(19) United States
(12) Patent Application Publication
(10) Pub. No.: US 2024/0248306 A1
(43) Pub. Date: Jul. 25, 2024

(54) VIRTUAL IMAGE DISPLAY DEVICE AND HEAD-MOUNTED DISPLAY APPARATUS

(71) Applicant: SEIKO EPSON CORPORATION, Tokyo (JP)

(72) Inventor: Takashi TAKEDA, SUWA-SHI (JP)

(73) Assignee: SEIKO EPSON CORPORATION, Tokyo (JP)

(21) Appl. No.: 18/415,522

(22) Filed: Jan. 17, 2024

(30) Foreign Application Priority Data
Jan. 19, 2023 (JP) 2023-006815

(51) Int. Cl. G02B 27/01

(52) U.S. Cl. CPC G02B 27/0172; G02B 2027/0112; G02B 2027/0178

(57) ABSTRACT

A virtual image display device includes: a display member including a wavelength-converting region that emits fluorescence upon being excited by image light as a pixel display region, a projection optical system that irradiates the wavelength-converting region with the image light, a light-blocking member arranged at the external side of the display member for suppressing incidence of external light on the wavelength-converting region, a first polarizing member arranged at the face side of the display member and including a first polarizing region, a second polarizing member arranged at the external side of a position of the first polarizing member and including a second polarizing region for restricting the external light to a second polarization direction, and a polarization separation lens element arranged at the face side of the first polarizing member and having refractive power that selectively acts on polarized light of the image light.

The present application is based on, and claims priority from JP Application Serial Number 2023-006815, filed Jan. 19, 2023, the disclosure of which is hereby incorporated by reference herein in its entirety.

### BACKGROUND

### 1. Technical Field

The present disclosure relates to a virtual image display device and a head-mounted display apparatus that enable observation of a virtual image, and more particularly to a virtual image display device and the like of a see-through type that enable visual recognition of an external image.

### 2. Related Art

As a see-through type virtual image display device that enables visual recognition of an outside world, a virtual image display device is known that includes a liquid crystal panel including an image display region and a transparent display region formed surrounding the image display region, and a light-guiding plate that guides backlight incident from a light source on an end portion, and in which the light-guiding plate includes a light-emitting region that irradiates the image display region of the liquid crystal panel with the backlight, and a light-transmitting region that transmits ambient light (WO 2016/056298). The display device is configured such that ambient light reaches an observer from the light-transmitting region of the light-guiding plate and the transparent display region of the liquid crystal panel, and the ambient light is transmitted through the light-emitting region of the light-guiding plate and the image display region of the liquid crystal panel and reaches the observer during a period in which the image display region is not irradiated with the backlight. With such a configuration, see-through display in which image light and ambient light are superimposed on each other is achieved.

In the above-described device, processing such as formation of dots and application of a scattering material is performed on the light-emitting region of the light-guiding plate, and the ambient light passing through the image display region of the liquid crystal panel passes through the processed light-emitting region, so that see-through transmittance decreases in a vicinity of a center of a visual field corresponding to the image display region. In order to achieve see-through display with high see-through transmittance in the vicinity of the center of the visual field, an optical system or the like with high see-through transmittance is separately required, which leads to an increase in size.

### SUMMARY

A virtual image display device according to an aspect of the present disclosure includes: a display member including a wavelength-converting region as a pixel display region, the wavelength-converting region being configured to emit fluorescence upon being excited by image light, a projection optical system configured to irradiate the wavelength-converting region with the image light as excitation light having a single wavelength, a light-blocking member arranged at an external side of the display member and configured to suppress incidence of external light on the wavelength-converting region, a first polarizing member arranged at a face side of the display member and including a first polarizing region provided corresponding to the wavelength-converting region, the first polarizing region being configured to restrict the image light displayed by the display member to a first polarization direction, a second polarizing member arranged at an external side of a position of the first polarizing member and including a second polarizing region configured to restrict the external light to a second polarization direction different from the first polarization direction, and a polarization separation lens element arranged at a face side of the first polarizing member and having refractive power configured to selectively act on polarized light of the image light.

### BRIEF DESCRIPTION OF THE DRAWINGS

FIG. 1 is an external perspective view for describing a mounted state of a virtual image display device of a first embodiment.

FIG. 2 is a conceptual perspective view for describing an optical structure of a display optical system.

FIG. 3 is a conceptual side view for describing the optical structure of the display optical system.

FIG. 4 is a conceptual enlarged perspective view for describing a repetition unit or a sub-pixel of a composite display member.

FIG. 5A is a plan view for describing a light-blocking member.

FIG. 5B is a plan view for describing a display member.

FIG. 5C is a plan view for describing a pattern polarizing member.

FIG. 6 is a diagram for describing an example of an irradiation state of a sub-pixel spot in a pixel section.

FIG. 7 is a diagram illustrating the light-blocking member, the display member and the pattern polarizing member in an overlapping manner.

FIG. 8 is a conceptual diagram for describing a projection optical system.

FIG. 9 is a diagram for describing a pixel or a sub-pixel formed by the projection optical system.

FIG. 10 is a conceptual perspective view for describing a structure and a function of a polarization separation lens element.

FIG. 11A is a conceptual diagram for describing operation of the virtual image display device of the first embodiment.

FIG. 11B is a conceptual diagram for describing the operation of the virtual image display device of the first embodiment.

FIG. 12 is a conceptual diagram for describing a virtual image display device of a second embodiment.

FIG. 13 is a conceptual diagram for describing a virtual image display device of a third embodiment.

FIG. 14A is a plan view for describing a pattern polarizing member of the third embodiment.

FIG. 14B is a plan view for describing an outside light polarizing member of the third embodiment.

FIG. 15 is a conceptual diagram for describing a virtual image display device of a fourth embodiment.

FIG. 16A is a conceptual diagram for describing a virtual image display device of a fifth embodiment.

FIG. 16B is a conceptual diagram for describing a modification example of the virtual image display device of the fifth embodiment.

FIG. 17 is a conceptual diagram for describing a virtual image display device of a sixth embodiment.

FIG. 18 is a conceptual diagram for describing a composite display member of the sixth embodiment.

FIG. 19 is a conceptual diagram for describing a modification example of the display member of the composite display member.

### DESCRIPTION OF EMBODIMENTS

### First Embodiment

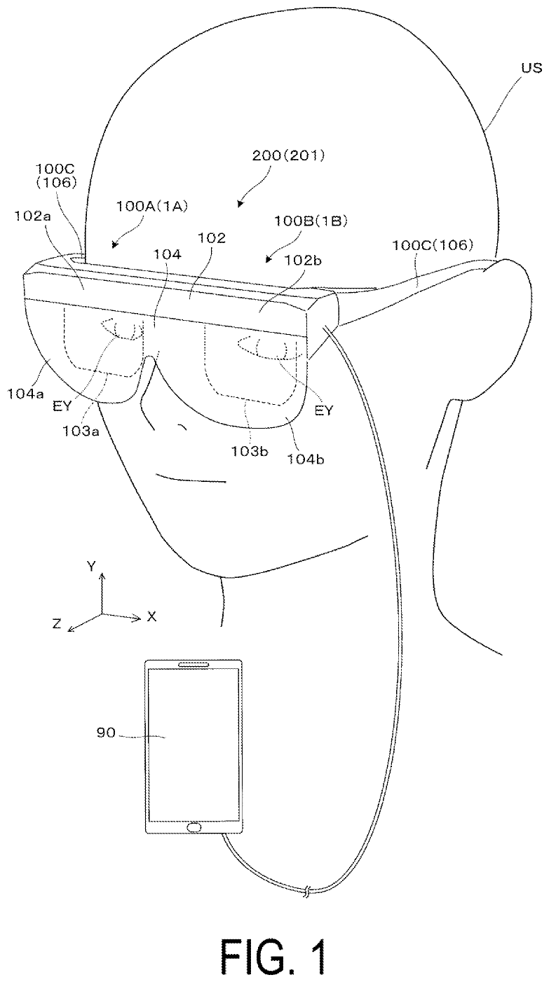

With reference to FIGS. 1 to 11, a virtual image display device according to a first embodiment of the present disclosure will be described below.

FIG. 1 is a perspective view for describing a mounted state of a head-mounted display, in other words, a head-mounted display apparatus 200. The head-mounted display apparatus (hereinafter also referred to as an HMD) 200 is a display apparatus 201 of a binocular type, and allows an observer or a wearer US who wears the HMD 200 to recognize a video as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The ±Y directions are parallel to a vertical axis or a vertical direction.

The HMD 200 includes a first virtual image display device 100A for a right eye, a second virtual image display device 100B for a left eye, a pair of temples 100C that support the virtual image display devices 100A and 100B, and a user terminal 90 being an information terminal. The first virtual image display device 100A is a first device 1A, and is constituted by a first display driving unit 102a that is arranged at an upper part, a first display optical system 103a that covers a front of the eye, and a light-transmitting cover 104a that covers the first display optical system 103a from the external side or a front side thereof. The second virtual image display device 100B is a second device 1B, and is constituted by a second display driving unit 102b that is arranged at an upper part, a second display optical system 103b that covers the front of the eye, and a light-transmitting cover 104b that covers the second display optical system 103b from the external side or the front side thereof. The HMD 200 obtained by combining the first virtual image display device 100A being the first device 1A and the second virtual image display device 100B being the second device 1B with each other is also a virtual image display device in a broader sense. The pair of temples 100C are mounting members or support devices 106 to be mounted on a head of the wearer US. The temples 100C support an upper end side of the pair of display optical systems 103a and 103b and an upper end side of the pair of light-transmitting covers 104a and 104b via the display driving units 102a and 102b integrated in appearance. A combination of the pair of display driving units 102a and 102b is referred to as a driving device 102. A combination of the pair of light-transmitting covers 104a and 104b is referred to as a shade 104.

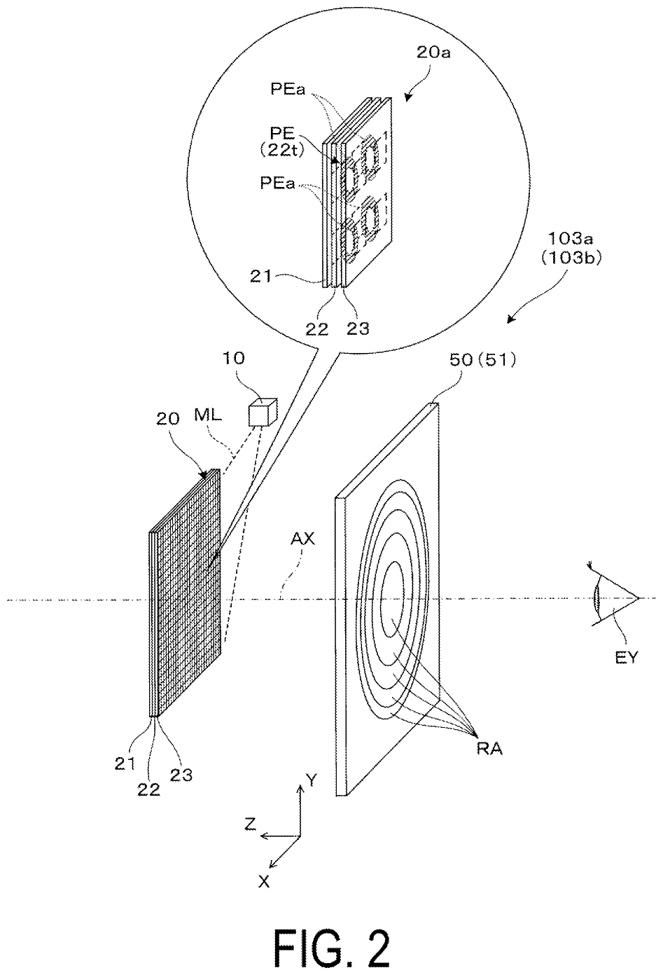

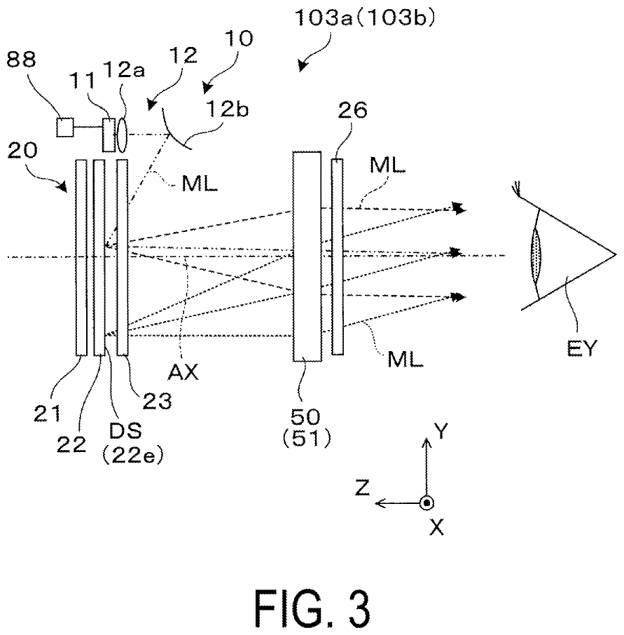

FIG. 2 is a conceptual perspective view for describing a structure of the first display optical system 103a. FIG. 3 is a conceptual side view for describing the structure of the first display optical system 103a. The first display optical system 103a includes a projection optical system 10, a composite display member 20, and a polarization separation lens element 50. The projection optical system 10 is arranged in an obliquely upward direction from the composite display member 20 so that the display member 22 of the composite display member 20 is irradiated with image light ML. The display member 22 is a passive image display member that functions as a screen for displaying an image by projection of projection light or the image light ML from the projection optical system 10. The composite display member 20 and the polarization separation lens element 50 are arranged spaced apart from each other in an optical axis AX direction. In the first display optical system 103a, a distance between the eye EY and the polarization separation lens element 50 is, for example, about 10 mm to 20 mm. Further, a distance between the display member 22 and the polarization separation lens element 50 is, for example, about 3 mm to 25 mm.

As illustrated in FIGS. 2 and 3, the composite display member 20 guides the image light ML emitted from the projection optical system 10 to the eye EY of the wearer US, that is, a pupil position of the wearer US. The composite display member 20 is a plate-like member extending parallel to an XY plane perpendicular to the optical axis AX. The composite display member 20 has a structure in which a light-blocking member 21, the display member 22, and a pattern polarizing member 23 are layered, and integrated by a frame body (not illustrated). In the illustrated example, in order to form a spot of the image light ML on the display member 22 of the composite display member 20, an arrangement is adopted in which the image light ML incident from the projection optical system 10 is incident on the display member 22 via the pattern polarizing member 23.

The composite display member 20 includes a plurality of repetition units 20a arrayed in a matrix along the XY plane. The repetition unit 20a includes a pixel section 22t corresponding to a pixel PE which is a unit for forming an image. The light-blocking member 21, the display member 22 and the pattern polarizing member 23 are bonded and fixed in a state of being arranged nearby with predetermined intervals therebetween. This makes it possible to make the device relatively thin. Note that the light-blocking member 21, the display member 22 and the pattern polarizing member 23 may be in close contact with each other. The arrangement of the display member 22 and the pattern polarizing member 23 is adjusted so that a polarization direction of the image light ML from the projection optical system 10 incident on the display member 22 via the pattern polarizing member 23 is the same as a polarization direction of the image light ML emitted in a wavelength-converting region 22e of the display member 22 and passing through the pattern polarizing member 23. Note that the pattern polarizing member 23 may be separated from the display member 22 in the optical axis AX direction, to cause the image light ML to be directly incident on the display member 22 from the projection optical system 10.

The polarization separation lens element 50 functions as a lens for the image light ML. The polarization separation lens element 50 is arranged at a face side, that is, the −Z side of the pattern polarizing member 23 of the composite display member 20 to cover the front of the eye. The polarization separation lens element 50 is an independent lens that collectively causes the plurality of pixels PE constituting the display member 22 to form an image. That is, the polarization separation lens element 50 collectively causes light corresponding to each pixel PE to form an image. By forming the polarization separation lens element 50 as an independent lens, an eye box can be easily enlarged. The polarization separation lens element 50 is a plate-like member that extends parallel to the XY plane. The polarization separation lens element 50 is specifically a liquid crystal lens 51, and includes a plurality of orbicular zones RA having circular shapes and different refractive index states, respectively. The orbicular zones RA in a group are concentrically arranged symmetrically about the optical axis AX. In the group of the orbicular zones RA, the orbicular zone RA in a periphery away from the optical axis AX has a width in a radial direction with the optical axis Ax as a center, which is smaller than that of the orbicular zone RA at a center through which the optical axis AX passes. In other words, the width of the orbicular zone RA in the radial direction is smaller as approaching the periphery.

The polarization separation lens element 50 acts on polarized light in a horizontal direction and does not act on polarized light in a perpendicular direction or the vertical direction. The polarization separation lens element 50 acting on the polarized light in the horizontal direction has a focal point at a display surface DS at which the wavelength-converting region 22e is formed or a position close thereto, or has refractive power comparable to a case in which the focal point is at the display surface DS or a position close thereto. Thus, the image light ML is emitted substantially parallel to the eye EY. As a result, an image and an external image are superimposed on the retina of the eye EY, and AR display can be performed.

As illustrated in FIG. 3, the first display optical system 103a includes an ultraviolet radiation blocking member 26 that absorbs or reflects ultraviolet light at the face side of the wavelength-converting region 22e or the display member 22. Accordingly, it is possible to prevent ultraviolet light from being incident on the eye EY of the wearer US. In the embodiment, the ultraviolet radiation blocking member 26 is provided on an emission side of the polarization separation lens element 50. Note that the ultraviolet radiation blocking member 26 may be provided at a position where the ultraviolet radiation blocking member 26 does not block the image light ML or excitation light incident on the display member 22 from the projection optical system 10, and between the display member 22 and the polarization separation lens element 50.

The second display optical system 103b is optically the same as the first display optical system 103a, or is obtained by inverting the first display optical system 103a horizontally. Thus, detail description thereof is omitted.

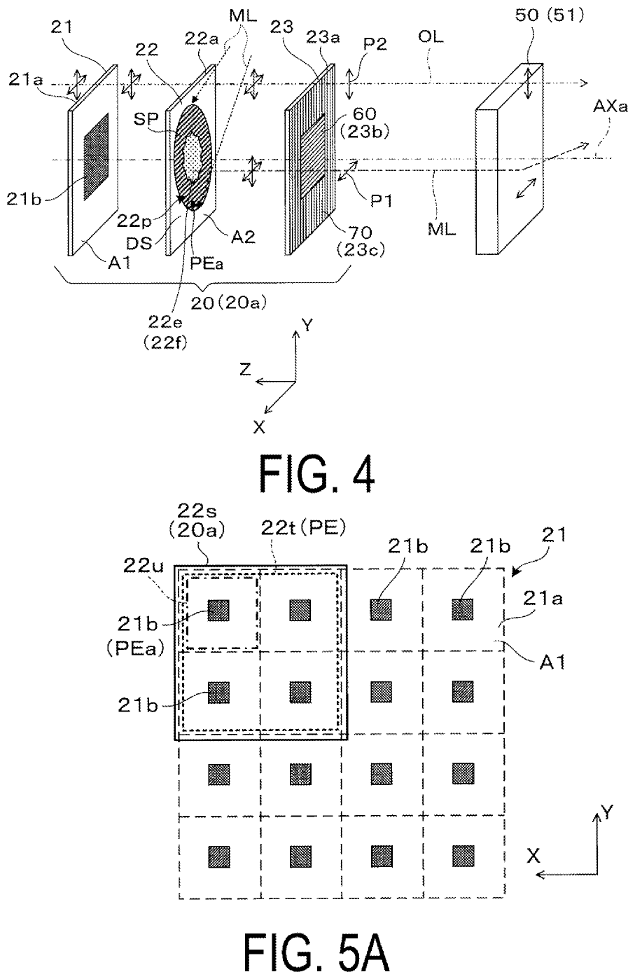

FIG. 4 is a partially enlarged perspective view for describing the repetition unit 20a of the composite display member 20. FIG. 4 illustrates a region corresponding to one sub-pixel PEa in the repetition unit 20a. Here, an axis AXa is an axis parallel to the optical axis AX illustrated in FIG. 1.

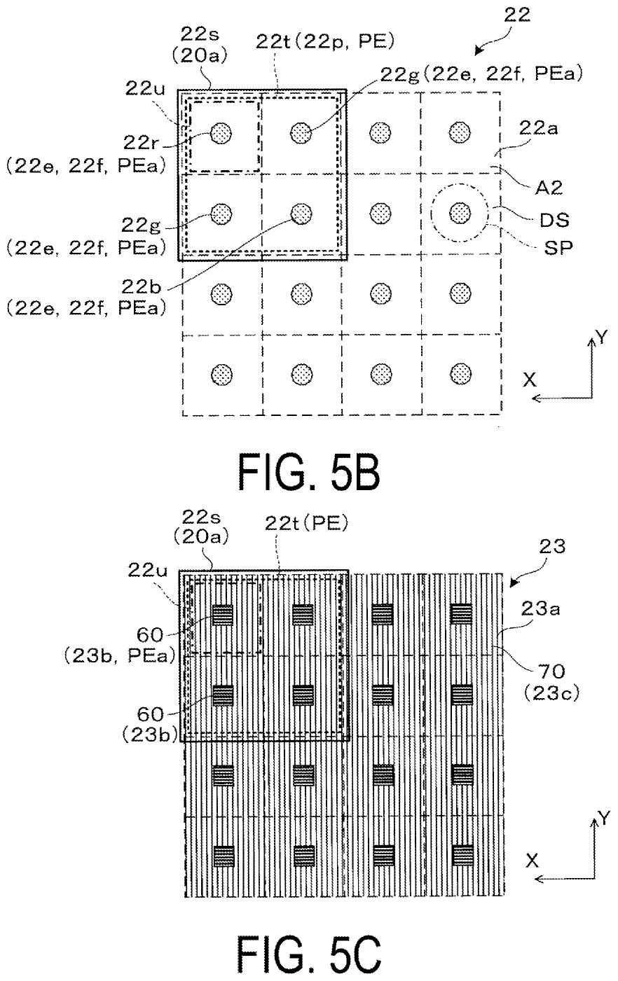

The light-blocking member 21 suppresses incidence of external light OL on the wavelength-converting region 22e of the display member 22. The light-blocking member 21 is obtained by providing a rectangular light-blocking layer 21b at a flat plate 21a that transmits light. As illustrated in FIG. 5A, at the entire light-blocking member 21, a large number of the light-blocking layers 21b are arrayed in a matrix along the XY plane. In other words, all the light-blocking layers 21b constituting the light-blocking member 21 are two-dimensionally arrayed periodically with respect to a horizontal X direction and a vertical Y direction. Each of the light-blocking layers 21b is formed in a region corresponding to the sub-pixel PEa of the pixel section 22t in each of the repetition units 20a. Note that the light-blocking layer 21b may be formed in a region corresponding to the pixel section 22t including the four sub-pixels PEa. The light-blocking layer 21b blocks light in a range equivalent to that of the sub-pixel PEa constituting the pixel PE or wider than that of the sub-pixel PEa. The light-blocking layer 21b has a size corresponding to the wavelength-converting region 22e. In this manner, incidence of the external light OL on the wavelength-converting region 22e can be suppressed. A light-transmitting region A1 of the light-blocking member 21 in which the light-blocking layer 21b is not provided transmits the external light OL, and the light-blocking layer 21b suppresses passage of the external light OL.

The light-blocking layer 21b is formed by light-absorbing paint or other substances that can be applied to a desired area by an ink-jet method, for example. A mold release pattern formed with a mold release agent is recorded in advance at a position at the flat plate 21a at which the light-blocking layer 21b is not formed. A spray containing light-absorbing substances is applied over the entire surface, and then the light-absorbing substances are removed at the position corresponding to the mold release pattern. With this, the light-blocking layer 21b may be made of the remaining light-absorbing substance layer. Paint having a color other than black may be used for the light-blocking layer 21b as long as substances contained therein have a light-absorbing action or a light-reflecting action. Moreover, a metal pattern is formed by using a photo-resist technique or the like at a position on the flat plate 21a at which the light-blocking layer 21b is to be formed, and the metal pattern is oxidized to improve an absorbing property. The light-blocking layer 21b may be thus formed. The light-blocking layer 21b may be a mirror made of a substance having reflectivity such as a metallic film. Note that the light-blocking layer 21b is not limited to one formed at the face side of the flat plate 21a and may be formed at the external side of the flat plate 21a.

The display member 22 illustrated in FIG. 4 and the like is arranged at the face side of the light-blocking member 21. The display member 22 reflects a part of the image light ML irradiated from the projection optical system 10 illustrated in FIG. 3 toward the eye EY of the wearer US, and functions as an image display member in the composite display member 20. The display member 22 includes the wavelength-converting regions 22e corresponding to a red phosphor, a green phosphor, and a blue phosphor at a flat plate 22a that transmits light. The display member 22 includes, at the display surface DS, a pixel display region 22p irradiated with a sub-pixel spot SP from an image display panel 11. The pixel display region 22p is a region that includes the sub-pixel PEa constituting the pixel PE, and on which the image light ML or the sub-pixel spot SP is incident. The wavelength-converting region 22e is formed in a range narrower than the pixel display region 22p.

The wavelength-converting region 22e emits fluorescence of any of red, green, or blue light by photoexcitation. In the embodiment, an example in which the image display panel 11 emits ultraviolet light as excitation light having a single wavelength will be described. In this case, since red light, green light, and blue light are emitted by ultraviolet light excitation, it is possible to prevent the blue light from being mixed with the red light and the green light.

The wavelength-converting region 22e includes a polygonal or circular outline in plan view. In addition, the wavelength-converting region 22e has a nanostructure that controls a direction of light.

The wavelength-converting region 22e includes a wavelength-converting layer 22f formed of a light-emitting material. The light-emitting material is a material that absorbs excitation light and emits light at a longer wavelength than that of the excitation light. Examples of the light-emitting material include inorganic phosphors, organic phosphors, organic fluorescent dyes, quantum dots, and the like. A quantum dot is a semiconductor fine particle having a diameter of 2 to 10 nanometers, and when excited by incident light, emits light of a color determined by the size and material of the particle. By using a light-emitting material that emits fluorescence, it is possible to increase luminance of the image light ML emitted from the display member 22.

The nanostructure of the wavelength-converting region 22e is formed by nanoimprint lithography, photolithography, or the like. The wavelength-converting layer 22f can be patterned by ink-jet printing, screen printing, or the like of a fluorescent material. Further, the wavelength-converting layer 22f can also be patterned by forming a mask and etching after spin coating of a fluorescent material. The nanostructure may be formed directly at the flat plate 22a, or at the wavelength-converting layer 22f.

Note that light scattering particles may be included in the wavelength-converting layer 22f to scatter the image light ML being fluorescence emitted from the display member 22 without providing the nanostructure at the wavelength-converting region 22e.

Of light with which the pixel display region 22p is irradiated, light incident on the wavelength-converting region 22e is reflected as fluorescence to the eye EY side, that is, forward, and light incident on a light-transmitting region A2 other than the wavelength-converting region 22e is transmitted or reflected and thus does not proceed to the eye EY side.

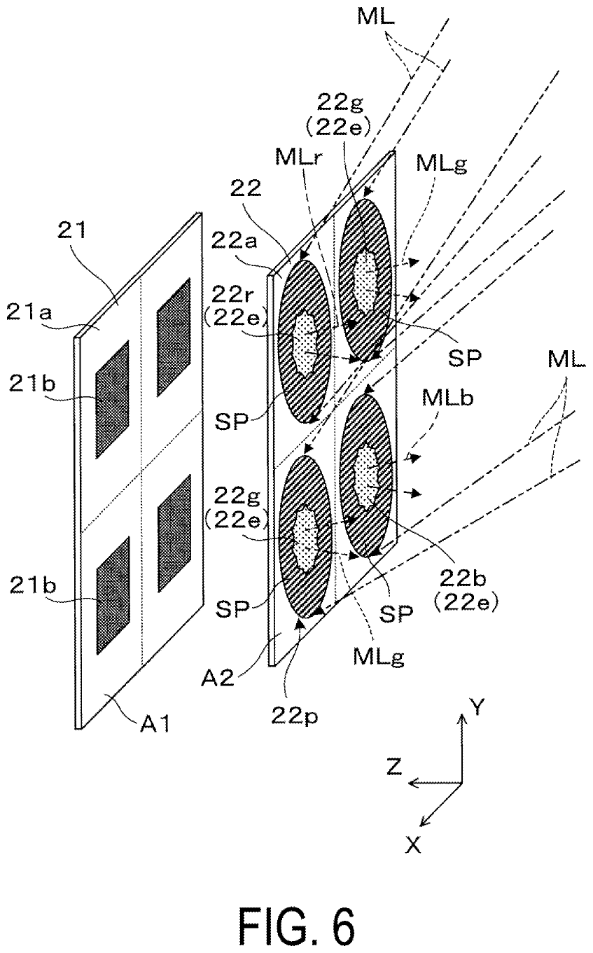

As illustrated in FIG. 6, in the display member 22, for example, in the pixel display region 22p of one pixel, the wavelength-converting regions 22e for respective colors, to be specific, a wavelength-converting region 22r for red fluorescence, a pair of wavelength-converting regions 22g for green fluorescence, and a wavelength-converting region 22b for blue fluorescence are provided. The wavelength-converting region 22r for the red fluorescence emits red image light MLr at timing and brightness necessary for display in accordance with light irradiation or the sub-pixel spot SP from the projection optical system 10. The pair of wavelength-converting regions 22g for the green fluorescence emit green image light MLg at timing and brightness necessary for display in accordance with light irradiation or the sub-pixel spot SP from the projection optical system 10. The wavelength-converting region 22b for the blue fluorescence emits blue image light MLb at timing and brightness necessary for display in accordance with light irradiation or the sub-pixel spot SP from the projection optical system 10. As illustrated in FIGS. 5B and 6, at the entire display member 22, a large number of the pixels PE each including a group of the four wavelength-converting regions 22r, 22g and 22b are arrayed in a matrix along the XY plane. In other words, all the pixels PE or all the groups of the wavelength-converting regions 22r, 22g and 22b that constitute the display member 22 are two-dimensionally arrayed periodically with respect to the horizontal X direction and the vertical Y direction. Of the display member 22, the light-transmitting region A2 in which the wavelength-converting regions 22r, 22g and 22b are not provided transmits the external light OL.

The flat plate 22a being a substrate at which the wavelength-converting region 22e is provided is formed of glass or plastic that transmits light. At the flat plate 22a, the wavelength-converting region 22e corresponding to one sub-pixel PEa is formed in the pixel display region 22p. One wavelength-converting region 22e corresponds to any of red, green, and blue in one pixel of the image display panel 11 forming the sub-pixel PEa. The wavelength-converting region 22e has a one-to-one relationship with the sub-pixel PEa, and one wavelength-converting region 22e is irradiated with the sub-pixel spot SP corresponding to one sub-pixel PEa. The wavelength-converting region 22e is a region of the pixel section 22t which is equal to the light-blocking layer 21b or smaller than the light-blocking layer 21b. The sub-pixel spot SP is larger than the wavelength-converting region 22e, and has a size such that the sub-pixel spot SP does not enter the adjacent wavelength-converting region 22e. By controlling an irradiation state (angular direction or range) of light corresponding to each sub-pixel PEa from the projection optical system 10, it is possible to selectively emit the image light ML in the wavelength-converting region 22e.

As illustrated in FIG. 5B, at the display member 22, repetition sections 22s each having a rectangular outline are arrayed in the X direction and the Y direction. Each repetition section 22s includes the pixel section 22t or the pixel PE, and the pixel section 22t includes a plurality of sub-pixel sections 22u. In the sub-pixel section 22u, the light-transmitting region A2 is formed around the wavelength-converting region 22e corresponding to the sub-pixel PEa. The pixel section 22t is the pixel display region 22p for displaying an image. The pixel section 22t includes the four wavelength-converting regions 22e arrayed in 2×2. In the first display optical system 103a, a size of a region where the pixels PE are formed is, for example, about 1 inch, and the number of pixels is about 2K to 4K. A size of the sub-pixel section 22u including the sub-pixel PEa is, for example, about 5 μm square to 20 μm square. A size of the wavelength-converting region 22e is, for example, about 2 μm square to 15 μm square. In order to ensure see-through light, (wavelength-converting region area)/(sub-pixel section area) is, for example, about 0.3 to 0.8. For example, when the pixel section 22t is 12 μm square, that is, when the sub-pixel section 22u is 6 μm square, the wavelength-converting region 22e is 4 μm square.

The pattern polarizing member 23 illustrated in FIG. 4 and the like is arranged at the face side of the display member 22. The pattern polarizing member 23 restricts the image light ML and the external light OL to a first polarization direction and a second polarization direction, respectively. By passing through the pattern polarizing member 23, the polarization direction of the image light ML and the polarization direction of the external light OL become different from each other.

The pattern polarizing member 23 includes a first polarizing member 60 and a second polarizing member 70. The first polarizing member 60 includes, for example, a rectangular first polarizing region 23b at a flat plate 23a that transmits light. The first polarizing regions 23b are discretely provided corresponding to the wavelength-converting regions 22e. The second polarizing member 70 includes a second polarizing region 23c that restricts the external light OL to the second polarization direction different from the first polarization direction. The second polarizing region 23c is provided in a region of the flat plate 23a other than the first polarizing member 60, that is, other than the first polarizing region 23b. The pattern polarizing member 23 is obtained by integrally incorporating the first polarizing member 60 and the second polarizing member 70. That is, the first polarizing member 60 and the second polarizing member 70 are formed at the same substrate. The first polarizing regions 23b are arrayed on lattice points as illustrated in the FIG. 5C, and the second polarizing region 23c is arranged around the first polarizing region 23b. Accordingly, it is possible to divide the first polarizing region 23b and the second polarizing region 23c in a planar manner, and it is possible to reduce the number of components while suppressing interference between the image light ML and the external light OL. As illustrated in FIG. 5C, at the entire pattern polarizing member 23, a large number of the first polarizing members 60 or the first polarizing regions 23b are arrayed in a matrix along the XY plane. In other words, all the first polarizing members 60 constituting the pattern polarizing member 23 are two-dimensionally arrayed periodically with respect to the horizontal X direction and the vertical Y direction. Of the pattern polarizing member 23, the second polarizing member 70 is not provided with the first polarizing member 60. The second polarizing member 70 restricts the external light OL to vertically polarized light in the second polarization direction. The first polarizing member 60 restricts the image light ML reflected in the wavelength-converting region 22e of the display member 22 to horizontally polarized light in the first polarization direction orthogonal to the second polarization direction. Note that all of the first polarizing members 60 or the first polarizing regions 23b are not limited to be discretely provided, and some of the first polarizing members 60 or the first polarizing regions 23b may be coupled to each other to an extent that polarizing control for the image light ML is not affected.

The pattern polarizing member 23 is, for example, a wire grid type polarizing plate and a fine grid made of metal such as aluminum is formed at the flat plate 23a made of glass or the like. The first polarizing region 23b and the second polarizing region 23c are patterned so that polarization directions are different by 90°. Note that it may also be possible to form only the first polarizing region 23b as a wire grid type polarizing plate, and to form the second polarizing region 23c by bonding an absorption-type polarizing film at the flat plate 23a. Here, the polarizing film is, for example, a resin sheet obtained by extending PVA with iodine adsorbed thereon in a specific direction.

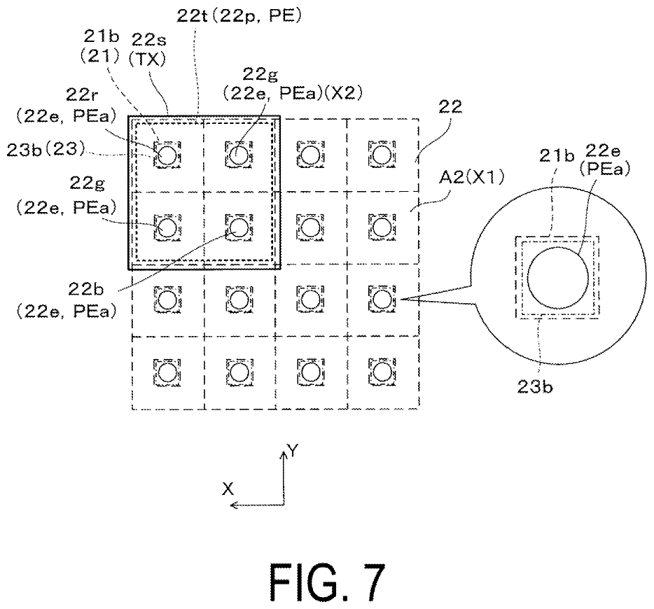

FIG. 7 is a diagram in which in the display member 22, the light-blocking member 21 and the pattern polarizing member 23 in a state of being seen-through are superimposed on each other and illustrated. In this case, the light-blocking layer 21b of the light-blocking member 21 is formed in a region that covers the sub-pixel PEa of the pixel section 22t, and that spreads slightly outward from the sub-pixel PEa, but may be formed in a region matching with the sub-pixel PEa. In addition, the light-blocking layer 21b of the light-blocking member 21 may be provided corresponding to a quadrangular frame surrounding a plurality of the sub-pixels PEa. The first polarizing region 23b of the pattern polarizing member 23 is formed in a region that covers the sub-pixel PEa of the pixel section 22t, and that spreads slightly outward from the sub-pixel PEa, but may be formed in a region matching with the sub-pixel PEa.

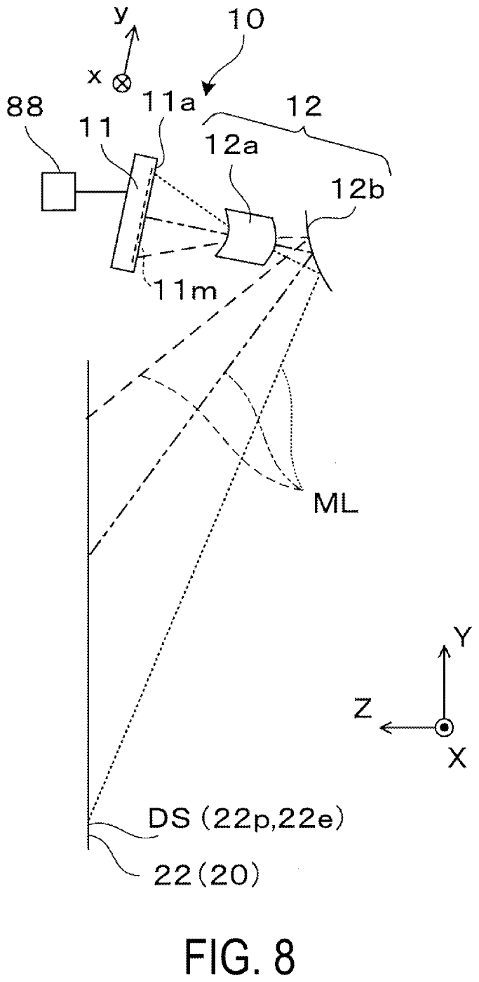

The projection optical system 10 illustrated in FIGS. 2, 3 and 8 forms a two dimensional image, and emits the image light ML from the image. As illustrated in FIGS. 3 and 8, the projection optical system 10 includes the image display panel 11, an imaging optical system 12 and a display control device 88. The projection optical system 10 projects light emitted from a light emitting region 11m of the image display panel 11 as the image light ML onto the display surface DS of the display member 22, to be specific, onto the wavelength-converting region 22e. That is, an image on the image display panel 11 is projected onto the corresponding wavelength-converting regions 22e, and an image to be displayed is formed on the display member 22. The image display panel 11 emits light having a single wavelength, specifically, ultraviolet light as excitation light.

The image display panel 11 is a self-luminous image light generating device. The image display panel 11 is, for example, an organic electroluminescence (EL) display, and forms a single color still image or moving image on a two-dimensional display surface 11a. The image display panel 11 is driven by the display control device 88 to perform display operation. The image display panel 11 is not limited to the organic EL display, and can be replaced with a display device using inorganic EL, an organic LED, an LED array, a laser array, a quantum dot light emission element, or the like.

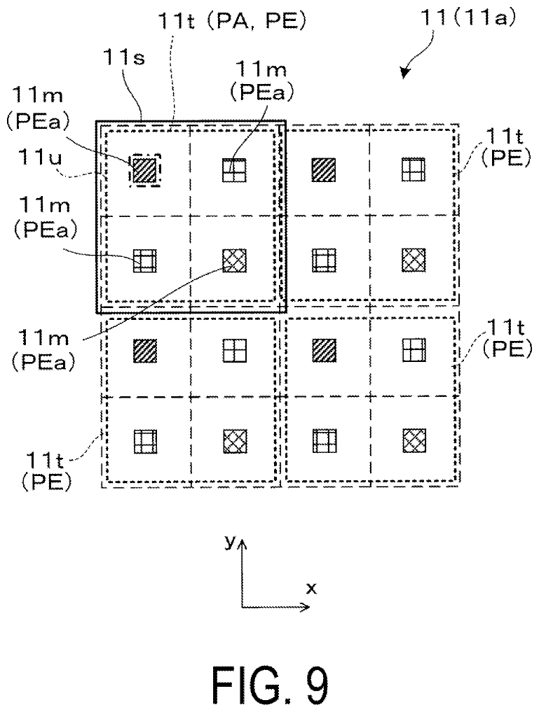

As illustrated in FIG. 9, in the image display panel 11, repetition sections 11s each having a rectangular outline are arrayed in an x direction and a y direction, each repetition section 11s includes a pixel section 11t, and the pixel section 11t includes a plurality of sub-pixel sections 11u. The pixel section 11t is a pixel display region PA for displaying an image. The pixel section 11t includes, for example, the four light emitting regions 11m arrayed in 2×2 in the sub-pixel section 11u. That is, at the image display panel 11, for example, a large number of the pixels PE each including a group of the four light emitting regions 11m are arrayed in a matrix along an xy plane. The pixel section 11t corresponds to the pixel PE. Each of the light emitting regions 11m corresponds to the sub-pixel PEa in the sub-pixel section 11u. The repetition section 11s corresponds to the repetition unit 20a of the composite display member 20 illustrated in FIGS. 2 and 5B. All the pixels PE or all the groups of the light emitting regions 11m that constitute the image display panel 11 are two-dimensionally arrayed periodically with respect to the x direction and the vertical y direction. In the illustrated example, the pixels PE or the light emitting regions 11m are arranged to be horizontally inverted with respect to projection on the display surface DS of the display member 22. The image display panel 11 selectively causes the light emitting regions 11m to emit light by the display control device 88.

As illustrated in FIGS. 3 and 8, the imaging optical system 12 includes a projection lens 12a and a reflection mirror 12b. The image display panel 11 and the imaging optical system 12 correspond to a part of the first display driving unit 102a illustrated in FIG. 1. The image display panel 11 and the imaging optical system 12 are fixed in a case (not illustrated) in a state of being aligned with each other. The imaging optical system 12 forms an image of the image light ML on the display surface DS of the display member 22. Light from the sub-pixel PEa is formed as the sub-pixel spot SP in the pixel display region 22p of the display member 22 by the imaging optical system 12.

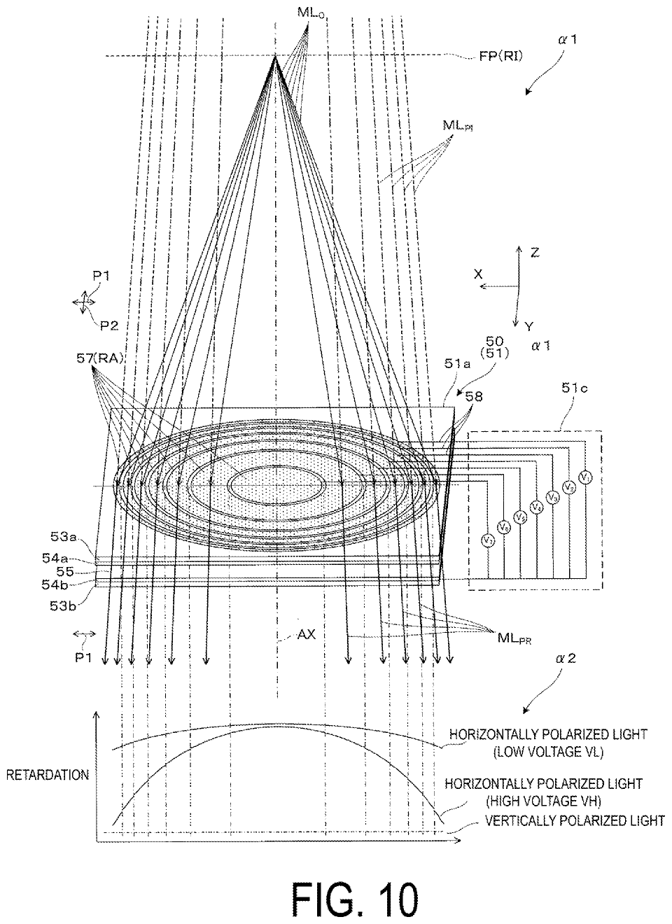

FIG. 10 is a diagram for describing a structure and a function of the polarization separation lens element 50 or the liquid crystal lens 51. In FIG. 10, an upper side α1 is a conceptual perspective view of the liquid crystal lens 51, and a lower side α2 is a chart illustrating a distribution state of retardation of the liquid crystal lens 51. The liquid crystal lens 51 is an optical element serving as a lens with respect to a specific polarization component. The liquid crystal lens 51 has refractive power that selectively acts on polarized light of the image light ML, and the refractive power is set for each of the orbicular zones RA. When vertically polarized light and horizontally polarized light are incident, the liquid crystal lens 51 selectively acts as a lens on the horizontally polarized light (first polarized light P1) in one direction according to distribution of a refractive index, and transmits the vertically polarized light (second polarized light P2) in another direction substantially as is without acting thereon. Here, the polarized light in the one direction specifically corresponds to the image light ML that is the horizontally polarized light including a polarization plane along the horizontal direction. The polarized light in the other direction specifically corresponds to the external light OL that is the vertically polarized light including a polarization plane along the vertical direction. The liquid crystal lens 51 can be used with a fixed focus, but may also be used with a variable focus. When the distribution of the refractive index on the liquid crystal lens 51 is increased or reduced overall, the refractive power of the liquid crystal lens 51 can be increased or reduced, and the liquid crystal lens 51 can be used with a variable focus.

The liquid crystal lens 51 as the polarization separation lens element 50 includes a lens member 51a and a driving circuit 51c. The lens member 51a includes two light-transmitting substrates 53a and 53b facing each other, two electrode layers 54a and 54b provided on inner surface sides of the light-transmitting substrates 53a and 53b, and a liquid crystal layer 55 interposed between the electrode layers 54a and 54b. Not that, although not illustrated in the drawing, alignment films are arranged between the electrode layers 54a and 54b and the liquid crystal layer 55 to adjust an initial alignment state of the liquid crystal layer 55. The first electrode layer 54a includes a large number of electrodes 57 arranged concentrically along the XY plane in the orbicular zone RA, and the electrodes 57 are annular transparent electrodes. The large number of electrodes 57 are spaced apart from each other, and a lateral width of the electrode 57 located on an outer side is narrowed. The lateral width of the electrode 57 affects accuracy of a refraction action of the lens member 51a. Each electrode 57 is coupled to the driving circuit 51c via a wiring line 58 insulated by an insulating layer (not illustrated), on a route in the middle. The second electrode layer 54b is a common electrode extending parallel to the XY plane, and is uniformly formed along the light-transmitting substrate 53b. Different application voltages V1 to V7 are applied to the large number of electrodes 57 to adjust a distribution state of birefringence or retardation. When the liquid crystal lens 51 has an effect of a convex lens, the application voltage V1 is set higher than the application voltage V7, and the application voltages V2 to V6 are set to values gradually changed within a voltage range of V1 to V7.

A case in which the image light ML emitted from the display member 22 is incident on the liquid crystal lens 51 via the pattern polarizing member 23 and the like, in other words, a case in which horizontally polarized light (first polarized light P1) including a polarization plane parallel to the X direction is incident on the liquid crystal lens 51 is considered. With regard to the horizontally polarized light, a voltage applied to the electrode 57 that is arranged at the outermost side in the peripheral portion is increased to reduce retardation, and the refractive index is relatively reduced in the region. Thus, for example, in a case of light from a far point light source, the light that passes through the liquid crystal lens 51 via the electrode 57 in the peripheral portion has a wavefront that is relatively advanced. In contrast, a voltage applied to the electrode 57 that is arranged at the innermost side being the center portion is reduced to maintain retardation close to its original state, and the refractive index is relatively increased in the region. Thus, for example, in a case of light from a far point light source, the light that passes through the liquid crystal lens 51 via the electrode 57 in the center portion has a wavefront that is relatively delayed. Thus, image light ML₀ in a diverging state that is incident on the liquid crystal lens 51 from an image RI set on a predetermined focal plane FP is horizontally polarized light, passes through the liquid crystal lens 51 to be subjected to an action as a convex lens, and becomes image light ML_{PR} in a state in which a diverging angle is reduced. Virtual image light ML_{PI} that traces back the image light ML_{PR} is from a virtual image position farther than the focal plane FP. A focal length of the liquid crystal lens 51 is a distance from a point light source to the liquid crystal lens 51 when light from the point light source is collimated. In the embodiment, the focal length is substantially equal to a distance from the display member 22 to the liquid crystal lens 51. Approximately, with reference to the lens formula, the relationship expressed by 1/F=1/A+1/B is satisfied, where a distance from the focal plane FP to the liquid crystal lens 51 is A, a distance from the liquid crystal lens 51 to an image plane is B, and the focal length of the liquid crystal lens 51 is F.

Here, the distance B from the focal plane FP to the virtual image position is set to a distance as several times to several tens of times as long as the distance A from the liquid crystal lens 51 to the focal plane FP. Although detail description is omitted, the distance ratio corresponds to a magnification ratio of a virtual image. In the above, when a relative ratio of the application voltages V1 to V7 is substantially maintained so that the application voltages are set to be low, a difference in retardation between the center and the periphery decreases, and an absolute value of positive power of the liquid crystal lens 51 decreases. That is, the absolute value of the power can be increased by applying a high voltage VH to the liquid crystal lens 51, the absolute value of the power can be decreased by applying a low voltage VL to the liquid crystal lens 51, and the driving circuit 51c can cause the liquid crystal lens 51 to function as an externally adjustable varifocal lens.

The liquid crystal lens 51 functions as a varifocal lens to change the focal length F. Thus, the distance B from the liquid crystal lens 51 to the image plane position or the virtual image position can freely be changed, and adjustment of a magnification ratio can be performed. Further, even when visual acuity of the wearer US is imbalanced due to nearsightedness or the like, focus adjustment for observing a virtual image while maintaining a focused state can be performed. In other words, the image plane position or the virtual image position can be adjusted finely according to visual acuity of an individual (farsightedness, nearsightedness, astigmatism, or the like). The wearer US can perform adjustment of a magnification ratio or focus adjustment by operating the user terminal 90, for example. In other words, the virtual image display devices 100A and 100B enable customization relating to a magnification ratio and focus by an operation by the wearer US.

The liquid crystal lens 51 has an image formation action with respect to the image light ML being horizontally polarized light or vertically polarized light. The liquid crystal lens 51 may be regarded as a liquid crystal lens including a function as a lens with respect to a specific polarization component, and may also be regarded as a liquid crystal lens having a lens function acting on a specific polarization component. When the liquid crystal lens 51 is arranged in front of the eyes, an eye box having a size close to that of the liquid crystal lens 51 can be secured. The eye box can be increased in size, and chipping of an image is less likely to occur. Moreover, the display optical systems 103a and 103b that are reduced in size and have a large FOV can be achieved at the same time. Moreover, by combining the composite display member 20 including the display member 22, the pattern polarizing member 23, and the like, with the liquid crystal lens 51, display on a large screen can be performed with a small-sized optical system. Here, display on a large screen indicates a case in which a virtual image of 70 inches or larger is formed at a distance of 2.5 m ahead, for example.

The liquid crystal lens 51 does not need to be used with a variable focus but can be used with a fixed focus. The liquid crystal lens 51 is not limited to one in which retardation is gradually reduced from the center to the periphery, but may also be a Fresnel lens as disclosed, for example, in WO 2009/072670. The liquid crystal lens 51 may change an alignment direction of liquid crystal by ultrasonic waves.

Note that the external light OL that passes through the light-blocking member 21 and the like is the vertically polarized light (second polarized light P2), and even when the external light OL passes through the liquid crystal lens 51, retardation is kept uniform in the XY plane regardless of the values of the application voltages V1 to V7. Thus, a phase difference is not imparted, and the external light OL is not affected by a lens action of the liquid crystal lens 51. In other words, the external light OL linearly advances without being substantially affected by the composite display member 20 and the polarization separation lens element 50.

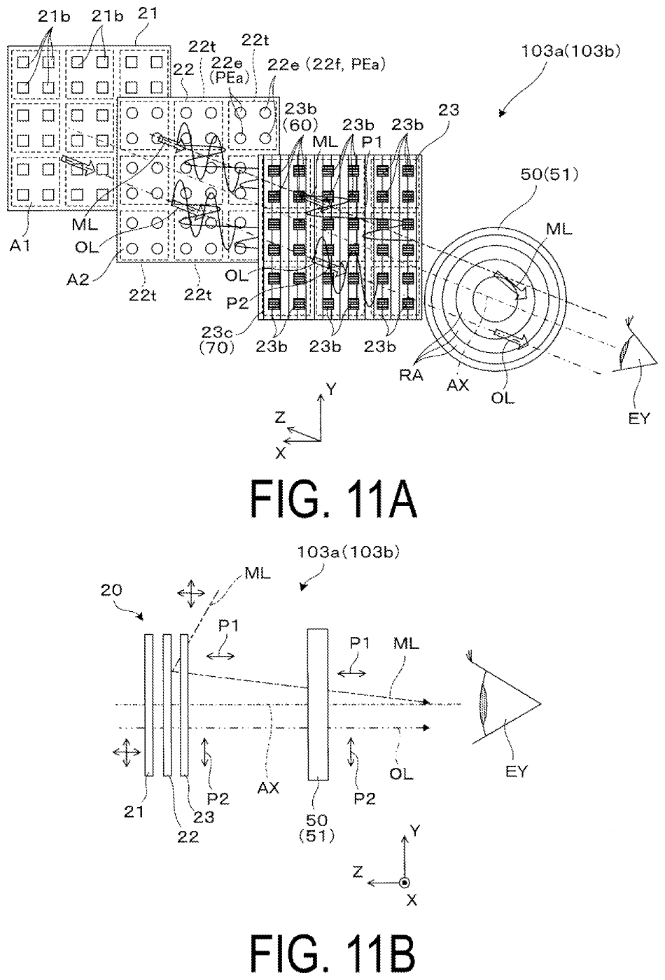

Referring to FIGS. 11A and 11B, the image light ML being, for example, ultraviolet light incident on the display member 22 is converted into fluorescence of any of red, green, and blue in the wavelength-converting region 22e. In other words, the wavelength-converting region 22e emits fluorescence of any of red, green, or blue light by ultraviolet light excitation. The image light ML as fluorescence reflected by the display member 22 passes through the first polarizing member 60 or the first polarizing region 23b of the pattern polarizing member 23 and is emitted as the first polarized light P1, to be more specific, as the horizontally polarized light. The image light ML that passes through the first polarizing member 60 forms a virtual image via the liquid crystal lens 51 as the polarization separation lens element 50 functioning as a convex lens with respect to the horizontally polarized light. An image that is formed at the image display panel 11 or the display member 22 is observed by the eyes EY of the wearer US as a virtual image at a desired magnification ratio behind the display member 22. On the other hand, the external light OL passes through the light-transmitting region A1 of the light-blocking member 21 and passes through the light-transmitting region A2 of the display member 22. Thereafter, the external light OL passes through the second polarizing member 70 or the second polarizing region 23c of the pattern polarizing member 23, and is emitted as the second polarized light P2, to be specific, the vertically polarized light. In this state, the external light OL is not subjected to a lens action due to the light-blocking member 21, the display member 22 and the pattern polarizing member 23. A general external image is observed by the eyes EY of the wearer US. In other words, an external image can be recognized in a see-through view via the display optical systems 103a and 103b.

In the above description, in the pattern polarizing member 23, the first polarization member 60 transmits only the image light ML being the horizontally polarized light, and the second polarizing member 70 transmits the external light OL being the vertically polarized light. However, the first polarizing member 60 may transmit the image light ML being the vertically polarized light, and the second polarizing member 70 may transmit the external light OL being the horizontally polarized light. With regard to the polarization separation lens element 50, it is necessary to change the polarization directions for the lens function accordingly as the function of the pattern polarizing member 23 is changed.

With reference to FIG. 7, the repetition section 22s may be regarded as a combination of an external light visual recognition pixel X1 being the light-transmitting region A2 and an image light emission pixel X2 being the sub-pixel PEa, and is also referred to as a see-through image display pixel TX. The see-through image display pixel TX may be regarded as a pixel that allows a background scene to be viewed in a see-through manner, from the viewpoint that the see-through image display pixel TX forms a pixel at a position where the external light OL is locally blocked. The external light OL that is not blocked by the light-blocking member 21 passes through the light-transmitting region A2 being a part of the see-through image display pixel TX of the display member 22 while the second polarizing member 70 of the pattern polarizing member 23 restricts the polarization direction, and passes through the liquid crystal lens 51 with a light beam state maintained. Meanwhile, the polarization direction of the image light ML that is emitted from the wavelength-converting region 22e of the image display region 22p being a part of the see-through image display pixel TX is restricted by the pattern polarizing member 23, and the image light ML passes through the liquid crystal lens 51 while being subjected to a light condensing action or a lens action, and is converted into a virtual image corresponding to display by the pixel display region 22p.

The virtual image display devices 100A and 100B according to the first embodiment described above each include: the display member 22 including the wavelength-converting region 22e that emits fluorescence upon being excited by the image light ML as the pixel display region 22p, the projection optical system 10 that irradiates the wavelength-converting region 22e with the image light ML as excitation light having a single wavelength, the light-blocking member 21 arranged at the external side of the display member 22 for suppressing incidence of the external light OL on the wavelength-converting region 22e, the first polarizing member 60 arranged at the face side of the display member 22 and including the first polarizing region 23b provided corresponding to the wavelength-converting region 22e for restricting the image light ML displayed by the display member 22 to the first polarization direction, the second polarizing member 70 arranged at the external side of a position of the first polarizing member 60 and including the second polarizing region 23c for restricting the external light OL to the second polarization direction different from the first polarization direction, and the polarization separation lens element 50 arranged at the face side of the first polarizing member 60 and having refractive power that selectively acts on polarized light of the image light ML. Note that the second polarizing member 70 or the second polarizing region 23c may be arranged slightly away from a position of the first polarizing member 60 or the first polarizing region 23b toward the face side as long as control of polarization is not affected. Also in this case, it is considered that the second polarizing member 70 is arranged at the external side of the position of the first polarizing member 60.

In the virtual image display devices 100A and 100B described above, the transmitted light that passes through the light-blocking member 21 from the outside world is restricted to the second polarization direction via the second polarizing member 70, and passes through the polarization separation lens element 50 without being subjected to an action of refractive power. The image light ML that is emitted from the wavelength-converting region 22e is restricted to the first polarization direction via the first polarizing member 60, passes through the polarization separation lens element 50 while being subjected to an action of refractive power, and forms a virtual image. In this case, a virtual image corresponding to an image formed in the wavelength-converting region 22e of the display member 22 can be formed while the display member 22 and the polarization separation lens element 50 are arranged near the eye EY, and an angle of view can be increased without separating the display member 22 and the polarization separation lens element 50 to a large degree. In particular, the polarization separation lens element 50 is an independent lens, and hence an eye box can be enlarged. In addition, it is possible to reduce a load of the projection optical system 10 by setting the image light ML emitted from the projection optical system 10 to be monochromatic and displaying the display member 22 in color with fluorescence.

### Second Embodiment

A virtual image display device according to a second embodiment will be described below. The virtual image display device according to the second embodiment is obtained by partially modifying the virtual image display device according to the first embodiment, and description of parts in common with those of the virtual image display device according to the first embodiment is omitted.

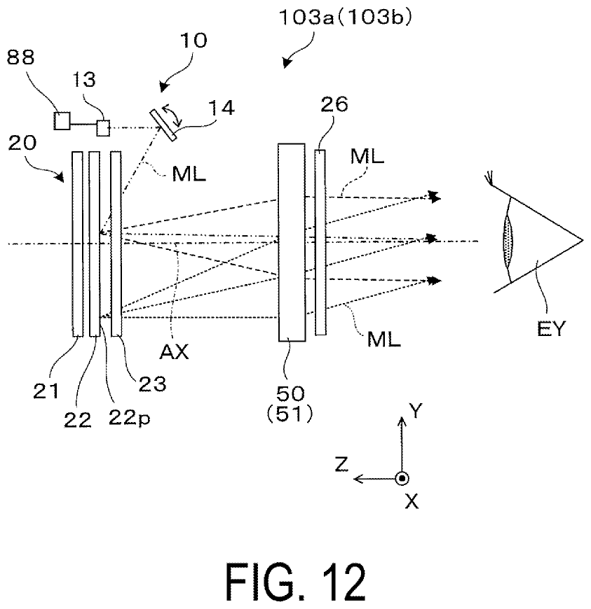

As illustrated in FIG. 12, the projection optical system 10 includes a laser light source 13 and a micro mirror 14 or an MEMS mirror. The projection optical system 10 projects modulated light from the laser light source 13 onto the pixel display region 22p of the display member 22 as the image light ML by the micro mirror 14 driven for scanning. In other words, a locus along which the modulated light moves on the display member 22 by the scanning corresponds to an image to be displayed. In the projection optical system 10, an angle of the image light ML emitted from the laser light source 13 is changed by the micro mirror 14 or the MEMS mirror, and the image light ML is emitted toward the composite display member 20. The projection optical system 10 projects the modulated light from the laser light source 13 onto the wavelength-converting region 22e (see FIG. 5B) as the image light ML by the micro mirror 14 driven for scanning.

Note that the projection optical system 10 according to the second embodiment can be used instead of the projection optical system 10 according to the first embodiment also in the virtual image display device 100A and the like according to third and subsequent embodiments.

### Third Embodiment

A virtual image display device according to a third embodiment will be described below. The virtual image display device according to the third embodiment is obtained by partially modifying the virtual image display device according to the first embodiment, and description of parts in common with those of the virtual image display device according to the first embodiment is omitted.

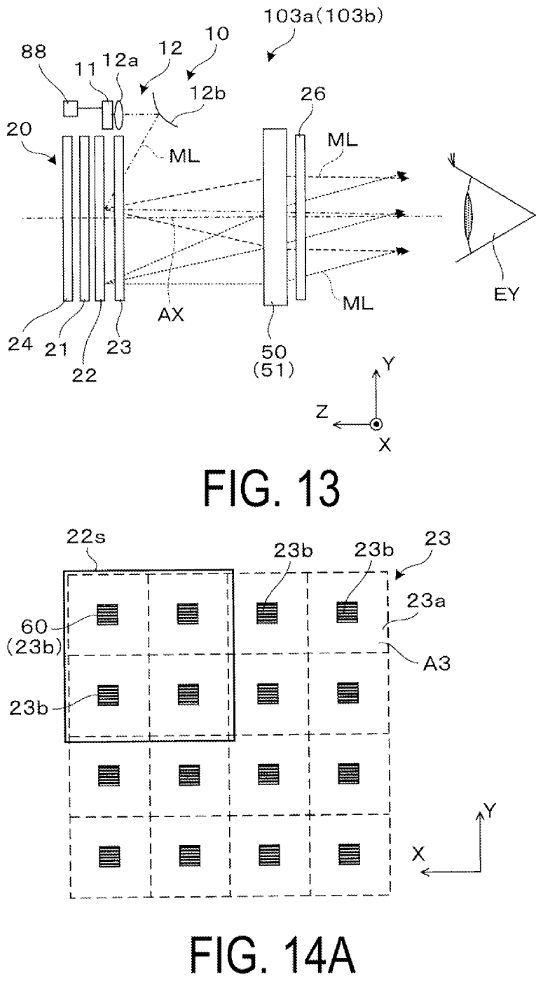

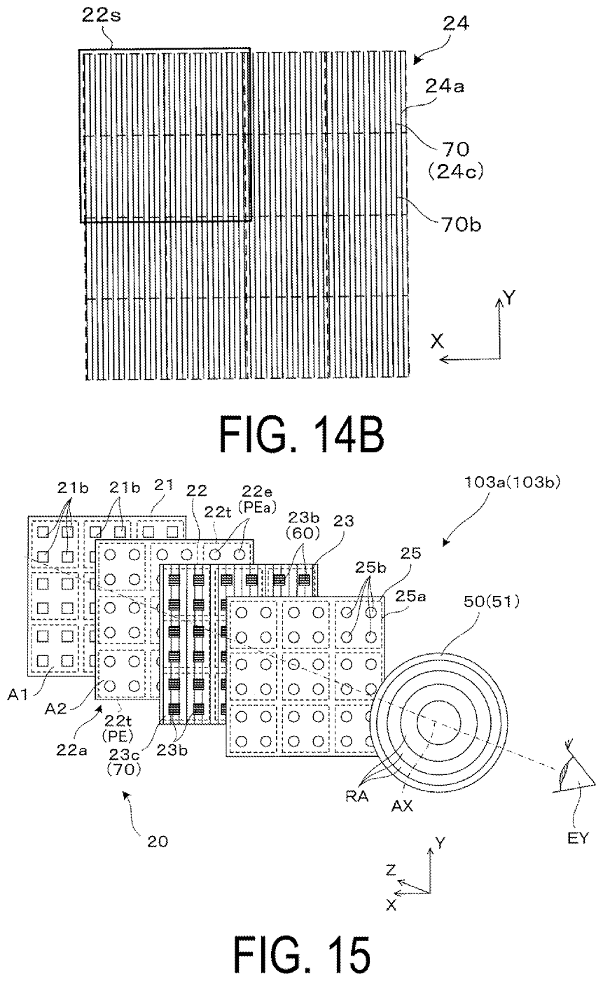

As illustrated in FIG. 13, in the embodiment, the display optical systems 103a and 103b each include an outside light polarizing member 24 at the external side of the light-blocking member 21. As illustrated in FIG. 14B, the outside light polarizing member 24 is the second polarizing member 70, and includes a second polarizing region 24c that restricts the external light OL to the second polarization direction or, to be more specific, to vertically polarized light. As illustrated in FIG. 14A, the pattern polarizing member 23 includes the first polarizing members 60 discretely provided at the flat plate 23a. The first polarizing member 60 includes the first polarizing region 23b that restricts the image light ML to the first polarization direction or, to be more specific, to the horizontally polarized light. That is, the first polarizing member 60 and the second polarizing member 70 are separate members. In the pattern polarizing member 23, a region other than the first polarizing member 60 or the first polarizing region 23b is a light-transmitting region A3, and the external light OL passing through the light-transmitting region A3 is not restricted in terms of the polarization direction.

The second polarizing member 70 is obtained by boning a polarizing film 70b of an absorbing type at a flat plate 24a that transmits light. The polarizing film 70b is, for example, a resin sheet obtained by extending PVA with iodine adsorbed thereon in a specific direction. In the illustrated example, the polarizing film 70b only transmits vertically polarized light having a polarization plane parallel to the vertical ±Y direction, and absorbs horizontally polarized light having a polarization plane parallel to the horizontal ±X direction. As a result, of the external light OL, the horizontally polarized light is blocked by the second polarizing member 70, and the vertically polarized light passes through the second polarizing member 70. Note that the polarizing film 70b may block the first polarized light P1 by reflection. The polarizing film 70b that blocks polarized light by reflection is, for example, a wire grid type polarizing plate, and a fine grid made of metal such as aluminum is formed at the flat plate 24a made of glass or the like.

### Fourth Embodiment

A virtual image display device according to a fourth embodiment will be described below. The virtual image display device according to the fourth embodiment is obtained by partially modifying the virtual image display device according to the first embodiment, and description of parts in common with those of the virtual image display device according to the first embodiment is omitted.

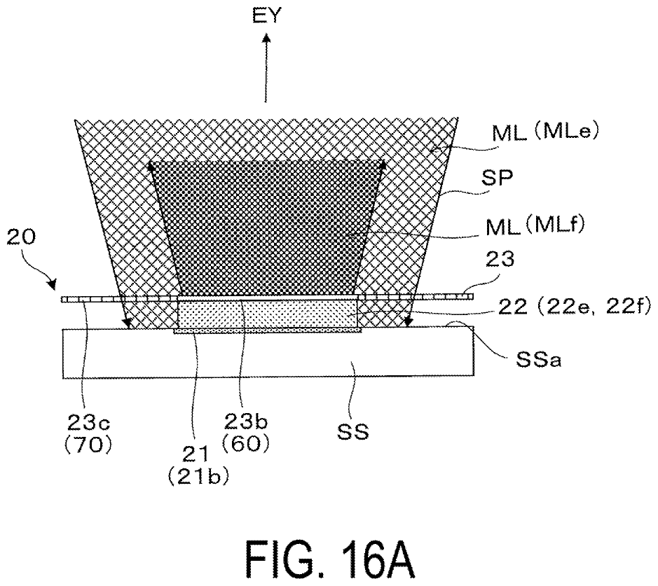

As illustrated in FIG. 15, in each of the display optical systems 103a and 103b of the embodiment, an optical array 25 is arranged between the composite display member 20 and the polarization separation lens element 50. The optical array 25 is obtained by providing circular or rectangular micro optical elements 25b at a flat plate 25a that transmits light in plan view. The micro optical element 25b individually adjusts a divergence state of the image light ML from the pixel PE or the sub-pixel PEa constituting the display member 22. The micro optical element 25b is, for example, a microlens.

Although omitted in illustration, at the entire optical array 25, a large number of the micro optical elements 25b are arrayed in a matrix along the XY plane. In other words, all the micro optical elements 25b constituting the optical array 25 are two-dimensionally arrayed periodically with respect to the horizontal X direction and the vertical Y direction. Each of the micro optical elements 25b is formed in a region corresponding to the sub-pixel PEa or the pixel PE in each of the repetition units 20a.

The micro optical element 25b is arranged in a vicinity of the display member 22, and hence the virtual image display device 100A can be easily reduced in thickness. In addition, by providing the microlens, a diffusion angle is further increased, and it is possible to increase an eye ring diameter when light is incident on the eye EY.

### Fifth Embodiment

A virtual image display device according to a fifth embodiment will be described below. The virtual image display device according to the fifth embodiment is obtained by partially modifying the virtual image display device according to the first embodiment, and description of parts in common with those of the virtual image display device according to the first embodiment is omitted.

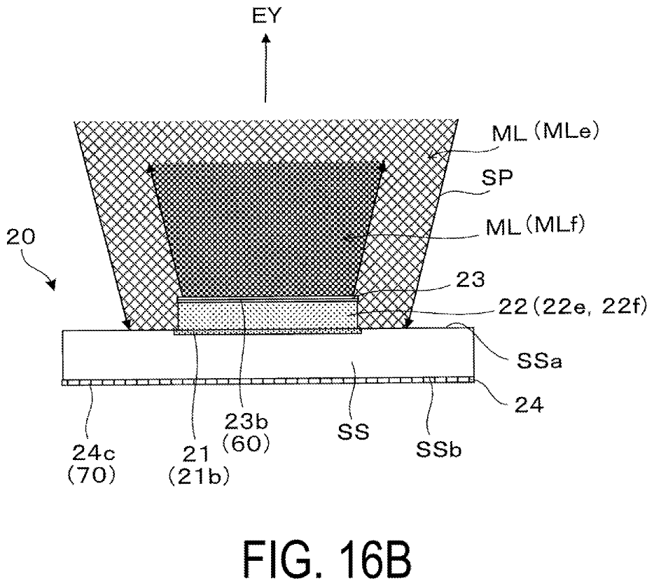

As illustrated in FIG. 16A, the members 21, 22 and 23 of the composite display member 20 of the embodiment are integrated at the same substrate. Specifically, at a first surface SSa which is one main surface of the substrate SS, the light-blocking member 21, the display member 22 and the pattern polarizing member 23 are arranged in this order from the external side. The members 21, 22, and 23 are structured by being in close contact with each other. Here, since the display member 22 is indirectly supported by the common substrate SS, the display member 22 is incorporated as the wavelength-converting region 22e from which a supporting flat plate is omitted, and the pattern polarizing member 23 is incorporated as the first polarizing region 23b and the second polarizing region 23c. By providing the wavelength-converting region 22e of the display member 22 at a front surface of the substrate SS, it is possible to suppress entry of excitation light into the substrate SS and to prevent occurrence of a ghost. In addition, by integrating the members 21, 22 and 23, the device can be reduced in thickness and weight. Note that the pattern polarizing member 23 may be provided with a support (not illustrated).

The substrate SS is made of glass or plastic that transmits light, for example. In the composite display member 20, the light-blocking layer 21b is formed at the substrate SS by vapor deposition and etching, and the wavelength-converting region 22e is formed at the light-blocking layer 21b. The wavelength-converting region 22e is obtained by, for example, performing patterning by mask etching or patterning by printing.

The image light ML or the sub-pixel spot SP as excitation light projected from the projection optical system 10 as projected light MLe is incident on the wavelength-converting region 22e of the display member 22 through the discretely formed first polarizing region 23b of the pattern polarizing member 23. Image light MLf incident on the wavelength-converting region 22e is emitted in a direction in which the image light MLf is reflected as fluorescence, passes through the first polarizing region 23b again, and horizontally polarized light in the first polarization direction is incident on the polarization separation lens element 50.

Note that as illustrated in FIG. 16B, each member of the composite display member 20 may be arranged similarly as in the third embodiment. In this case, the light-blocking member 21, the display member 22, and the pattern polarizing member 23 of the composite display member 20 are layered and formed at the first surface SSa at the face side of the substrate SS, and the outside light polarizing member 24 is formed at a second surface SSb at the external side of the substrate SS.

### Sixth Embodiment

A virtual image display device according to a sixth embodiment will be described below. The virtual image display device according to the sixth embodiment is obtained by partially modifying the virtual image display device according to the first embodiment, and description of parts in common with those of the virtual image display device according to the first embodiment is omitted.

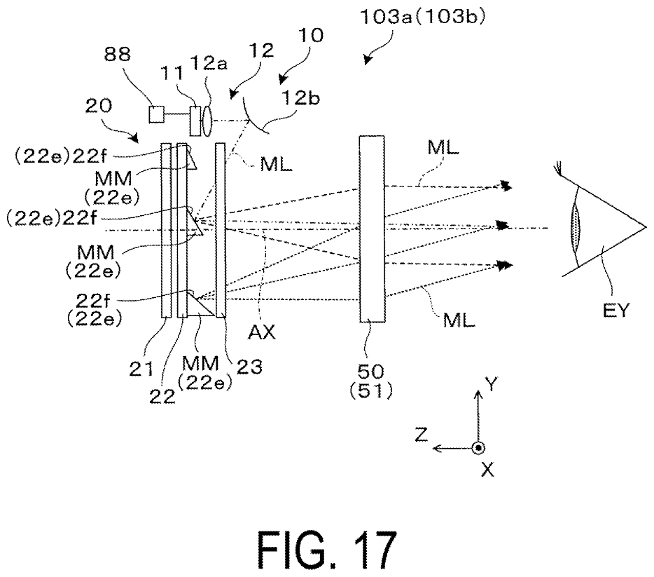

As illustrated in FIG. 17, in the embodiment, the display member 22 includes the wavelength-converting layer 22f as the wavelength-converting region 22e, and a micro mirror MM for controlling a direction of light. The micro mirror MM is a member that guides excited fluorescence of the image light ML in a direction of the eye EY. An inclination angle of the micro mirror MM depends on positions of the pixel PE. Note that the micro mirror MM may be provided with a scattering structure such as a nanostructure.

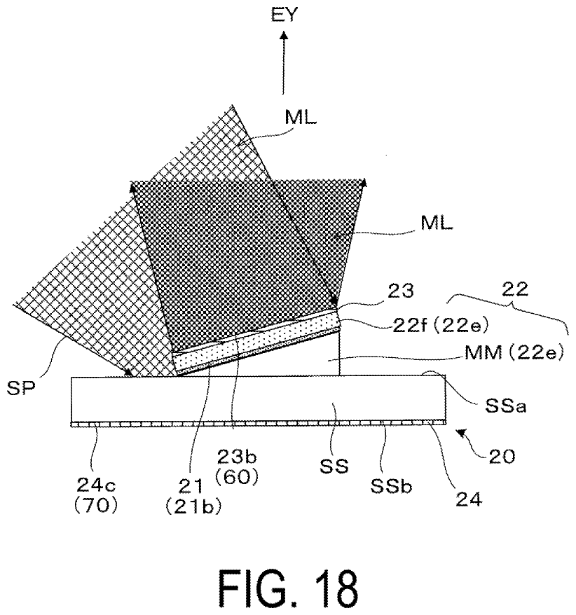

FIG. 18 illustrates a specific example of the composite display member 20 of the embodiment in which the members 21, 22 and 23 are integrally arranged. The composite display member 20 illustrated in FIG. 18 has a structure similar to that of the composite display member 20 illustrated in FIG. 16B, in which the display member 22, the light-blocking member 21, and the pattern polarizing member 23 are formed at the first surface SSa at the face side of the substrate SS, and the outside light polarizing member 24 is formed at the second surface SSb at the external side of the substrate SS. In FIG. 18, the light-blocking layer 21b is formed at a front surface of the micro mirror MM which is a part of the display member 22, and the display member 22 or the wavelength-converting region 22e is provided thereat. The wavelength-converting layer 22f of the display member 22 is provided between the light-blocking layer 21b and the first polarizing member 60 of the pattern polarizing member 23.

### Modification Examples and Others

Although the present disclosure has been described with reference to the above-described embodiments, the present disclosure is not limited to the above-described embodiments and can be implemented in various modes without departing from the spirit of the disclosure. For example, the following modifications are possible.

In the embodiment described above, the liquid crystal lens 51 is not limited to one including the electrode as an element, and may be one having refractive power by filling a space between a Fresnel lens-like first substrate and a flat plate-like second substrate with liquid crystal and aligning the alignment of the liquid crystal with a Fresnel lens surface.

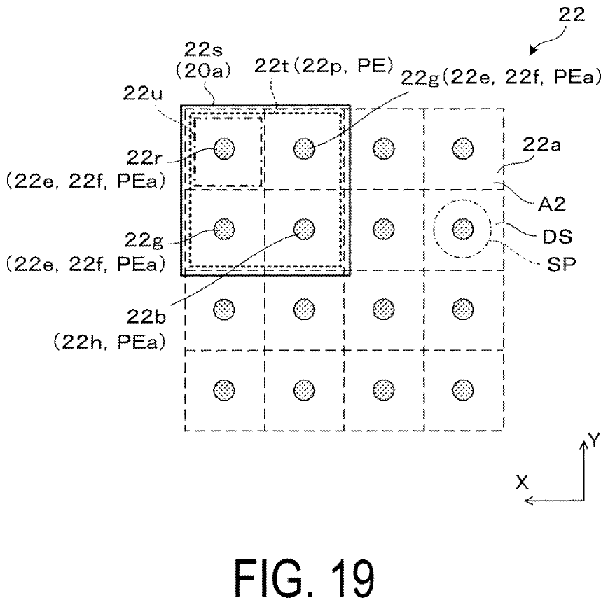

In the embodiment described above, the image light ML or the excitation light emitted from the projection optical system 10 is not limited to ultraviolet light, but may be blue light. In this case, as illustrated in FIG. 19, the display member 22 includes the wavelength-converting region 22e that emits fluorescence of any of red or green light by blue light excitation, and a scattering region 22h that scatters the blue light. The wavelength-converting region 22e is provided with the wavelength-converting layer 22f, and the scattering region 22h is not provided with the wavelength-converting layer 22f. In the first virtual image display device 100A or the first display optical system 103a including the display member 22 illustrated in FIG. 19, the ultraviolet radiation blocking member 26 illustrated in FIG. 3 is not required.

The liquid crystal lens 51 may include an elongated circular electrode that is slightly elongated in a specific direction, instead of a circular electrode.

The liquid crystal lens 51 as the polarization separation lens element 50 is not limited to a lens including the orbicular zone RA having a ring shape. As the polarization separation lens element 50, various structures having a lens action with respect to specific polarized light may be adopted.

Although it has been assumed above that the HMD 200 is worn on the head and is used, the virtual image display devices 100A and 100B may also be used as a hand-held display that is not worn on the head and is to be looked into like binoculars. In other words, the head-mounted display according to an aspect of the present disclosure also includes a hand-held display.

In the embodiment described above, the arrangement and size of the pixel PE or the sub-pixel PEa can be changed as appropriate so that a sufficient see-through region exists in one pixel.

A virtual image display device in a specific aspect includes: a display member including a wavelength-converting region that emits fluorescence upon being excited by image light as a pixel display region, a projection optical system that irradiates the wavelength-converting region with the image light as excitation light having a single wavelength, a light-blocking member arranged at the external side of the display member for suppressing incidence of external light on the wavelength-converting region, a first polarizing member arranged at the face side of the display member and including a first polarizing region provided corresponding to the wavelength-converting region for restricting the image light displayed by the display member to a first polarization direction, a second polarizing member arranged at the external side of a position of the first polarizing member and including a second polarizing region for restricting the external light to a second polarization direction different from the first polarization direction, and a polarization separation lens element arranged at the face side of the first polarizing member and having refractive power that selectively acts on polarized light of the image light.

In the virtual image display device described above, the transmitted light that passes through the light-blocking member from an outside world is restricted to the second polarization direction via the second polarizing member, and passes through the polarization separation lens element without being subjected to an action of refractive power. The image light that is emitted from the wavelength-converting region is restricted to the first polarization direction via the first polarizing member, passes through the polarization separation lens element while being subjected to an action of refractive power, and forms a virtual image. In this case, a virtual image corresponding to an image formed in the wavelength-converting region of the display member can be formed while the display member and the polarization separation lens element are arranged near an eye, and an angle of view can be increased without separating the display member and the polarization separation lens element to a large degree. In addition, it is possible to reduce a load of the projection optical system by setting the image light emitted from the projection optical system to be monochromatic and displaying the display member in color with fluorescence.

In a virtual image display device in a specific aspect, the excitation light is ultraviolet light, and the wavelength-converting region emits fluorescence of any of red light, green light, and blue light by ultraviolet light excitation. In this case, since red light, green light, and blue light are emitted by ultraviolet light excitation, it is possible to prevent the blue light from being mixed with the red light and the green light.

A virtual image display device in a specific aspect includes an ultraviolet radiation blocking member that absorbs or reflects ultraviolet light at the face side of a display region. In this case, it is possible to prevent the ultraviolet light from entering eyes of a wearer.

In a virtual image display device in a specific aspect, the excitation light is blue light, the display member includes a scattering region that scatters the blue light, and the wavelength-converting region emits fluorescence of any of red light and green light by blue light excitation. In the virtual image display device including the display member, the ultraviolet radiation blocking member is not necessary.

In a virtual image display device in a specific aspect, the display member includes the wavelength-converting region, and a light-transmitting region that enables visual recognition of an outside world.

In a virtual image display device in a specific aspect, the first polarizing regions are discretely provided corresponding to the wavelength-converting regions.

In a virtual image display device in a specific aspect, the light-blocking member includes a light-blocking layer that suppresses incidence of the external light, and the light-blocking layer has a size corresponding to that of the display region. In this manner, incidence of the external light on the display region can be further suppressed.

In a virtual image display device in a specific aspect, the first polarizing member and the second polarizing member are arranged at the same substrate, and the second polarizing region is arranged around the first polarizing region. Accordingly, it is possible to divide the first polarizing region and the second polarizing region in a planar manner, and it is possible to reduce the number of components while suppressing interference between the image light and the external light.

In a virtual image display device in a specific aspect, the polarization separation lens element is a polarization separation liquid crystal lens that causes a plurality of pixels constituting the display member to collectively form an image. With an independent lens, an eye box can be enlarged.

In a virtual image display device in a specific aspect, the projection optical system includes an image display panel that displays an image, and projects light emitted from a light-emitting region of the image display panel onto the pixel display region as the image light. That is, an image on the image display panel is projected onto the corresponding pixel display region, and an image to be displayed is formed on the display member.

In a virtual image display device in a specific aspect, the projection optical system projects modulated light from a laser light source onto the pixel display region as the image light, by a micro mirror driven for scanning. In other words, a locus along which the modulated light moves on the display member by the scanning corresponds to an image to be displayed.

In a virtual image display device in a specific aspect, the light-blocking member, the display member, and the first polarizing member are integrated. Accordingly, it is possible to reduce the device in thickness and weight.

In a virtual image display device in a specific aspect, the display member includes a wavelength-converting region for red fluorescence, a wavelength-converting region for green fluorescence, and a wavelength-converting region for blue fluorescence, and includes a light-transmitting region that transmits the external light in a region where the wavelength-converting region is not arranged.

According to a specific aspect, a head-mounted display apparatus includes a first device including the virtual image display device described above, a second device including the virtual image display device described above, and a support device including a temple supporting the first device and the second device, the temple being configured to enable mounting of the first device and the second device on a head.

What is claimed is:

1. A virtual image display device, comprising:
a display member including a wavelength-converting region as a pixel display region, the wavelength-converting region being configured to emit fluorescence upon being excited by image light;
a projection optical system configured to irradiate the wavelength-converting region with the image light as excitation light having a single wavelength;
a light-blocking member arranged at an external side of the display member and configured to suppress incidence of external light on the wavelength-converting region;
a first polarizing member arranged at a face side of the display member and including a first polarizing region provided corresponding to the wavelength-converting region, the first polarizing region being configured to restrict the image light displayed by the display member to a first polarization direction;
a second polarizing member arranged at an external side of a position of the first polarizing member and including a second polarizing region configured to restrict the external light to a second polarization direction different from the first polarization direction; and
a polarization separation lens element arranged at a face side of the first polarizing member and having refractive power configured to selectively act on polarized light of the image light.

2. The virtual image display device according to claim 1, wherein
the excitation light is ultraviolet light and
the wavelength-converting region emits fluorescence of any of red light, green light, and blue light by ultraviolet light excitation.

3. The virtual image display device according to claim 2, further comprising
an ultraviolet radiation blocking member configured to absorb or reflect the ultraviolet light at a face side of the wavelength-converting region.

4. The virtual image display device according to claim 1, wherein
the excitation light is blue light,
the display member includes a scattering region configured to scatter the blue light, and
the wavelength-converting region emits fluorescence of any of red light and green light by blue light excitation.

5. The virtual image display device according to claim 1, wherein
the display member includes the wavelength-converting region, and a light-transmitting region enabling visual recognition of an outside world.

6. The virtual image display device according to claim 1, wherein
the first polarizing regions are discretely provided corresponding to the wavelength-converting regions.

7. The virtual image display device according to claim 1, wherein
the light-blocking member includes a light-blocking layer configured to suppress incidence of the external light, and
the light-blocking layer has a size corresponding to that of the wavelength-converting region.

8. The virtual image display device according to claim 1, wherein
the first polarizing member and the second polarizing member are arranged at the same substrate, and
the second polarizing region is arranged around the first polarizing region.

9. The virtual image display device according to claim 1, wherein
the polarization separation lens element is a polarization separation liquid crystal lens configured to cause a plurality of pixels constituting the display member to collectively form an image.

10. The virtual image display device according to claim 1, wherein
the projection optical system includes an image display panel configured to display an image, and projects light emitted from a light-emitting region of the image display panel onto the pixel display region as the image light.

11. The virtual image display device according to claim 1, wherein
the projection optical system projects modulated light from a laser onto the pixel display region as the image light, by a micro mirror driven for scanning.

12. The virtual image display device according to claim 1, wherein
the light-blocking member, the display member, and the first polarizing member are integrated in order from an external side.

13. The virtual image display device according to claim 1, wherein
the display member includes a wavelength-converting region for red fluorescence, a wavelength-converting region for green fluorescence, and a wavelength-converting region for blue fluorescence, and includes a light-transmitting region in a region where the wavelength-converting region is not arranged, the light-transmitting region being configured to transmit the external light.

14. A head-mounted display apparatus comprising:
a first device and a second device each including the virtual image display device according to claim 1; and
a support device including a temple supporting the first device and the second device, the temple being configured to enable mounting of the first device and the second device on a head.
